(19) United States
(12) Patent Application Publication
(10) Pub. No.: US 2026/0151862 A1
(43) Pub. Date: Jun. 4, 2026

(54) WEAR-RESISTANT BRAZING FILLER METAL, PREPARATION METHOD AND USE THEREOF

(71) Applicant: China Academy of Machinery Zhengzhou Research Institute of Mechanical Engineering Co., Ltd., Zhengzhou (CN)

(72) Inventors: Jian Qin, Zhengzhou (CN); Weimin Long, Zhengzhou (CN); Sujuan Zhong, Zhengzhou (CN); Junlan Huang, Zhengzhou (CN); Yuan Sun, Zhengzhou (CN); Sheng Liu, Zhengzhou (CN); Peng Guo, Zhengzhou (CN)

(73) Assignee: China Academy of Machinery Zhengzhou Research Institute of Mechanical Engineering Co., Ltd., Zhengzhou (CN)

(21) Appl. No.: 19/403,309

(22) Filed: Nov. 28, 2025

(30) Foreign Application Priority Data
Nov. 29, 2024 (CN) 202411747687.5

(51) Int. Cl. B23K 35/30; B23K 35/02; B23K 35/40

(52) U.S. Cl. CPC B23K 35/302; B23K 35/0227; B23K 35/406

(57) ABSTRACT

A brazing filler metal, a preparation method and use thereof relate to the technical field of brazing materials. The brazing filler metal includes a strip-shaped wear-resistant body and at least one brazing filler metal tube sleeved on the outside of the strip-shaped wear-resistant body, the strip-shaped wear-resistant body includes a plurality of wear-resistant particles located in the core and a metal mesh wrapped around the outside of the plurality of wear-resistant particles, and outer surfaces of the wear-resistant particles are coated with a brazing flux layer.

### CROSS REFERENCE TO THE RELATED APPLICATIONS

This application is based upon and claims priority to Chinese Patent Application No. 202411747687.5, filed on Nov. 29, 2024, the entire contents of which are incorporated herein by reference.

### TECHNICAL FIELD

The present disclosure relates to the technical field of brazing materials, and specifically relates to a wear-resistant brazing filler metal, a preparation method and use thereof.

### BACKGROUND

As operating environments of workpieces (super hard tools such as shield cutter, oil drill bits, cutting teeth, etc.) become increasingly extreme and complex, graded and different requirements are proposed for performance demands of a brazing filler metal. For example, brazing of a cutter head at the center of the shield cutter requires high brazing temperatures and requires the brazing filler metal with good wettability and low melting temperatures; and brazing of the cutter head at the edge of the shield cutter requires lower brazing temperatures (induction heating and high edge temperatures) and requires the brazing filler metal with slightly higher melting temperatures and non-spreading properties. Similarly, for a shield cutterhead, the edge of the cutterhead experiences severe wear, requiring the brazing filler metal with high wear-resistance, while the center of the cutterhead experiences greater stress, requiring the brazing filler metal with high strength.

Current brazing filler metals used for brazing the super hard tools, a shear strength of a joint is generally around 220 MPa and an operating temperature is around 300° C. This not only fails to meet the requirements of highly reliable mechanical properties and high wear resistance of the super hard tools, but also fixed composition of the brazing filler metal fails to meet the requirements of diverse brazing performance of the super hard tools. Current method is using conventional brazing filler metal to braze shield cutter, and using wear-resistant coating materials to cover a metallurgical wear-resistant layer on the surface of the cutterhead by melting. The process is complex and requires various materials.

To overcome the above shortcomings, it is necessary to develop a brazing filler metal with high strength, high wear-resistance and replaceable components, suitable for highly reliable brazing of the super hard tools.

In view of this, the present disclosure is proposed specifically.

### SUMMARY

The first objective of the present disclosure is to provide a brazing filler metal with high strength, high wear-resistance and replaceable components to solve the technical problems of low strength, poor wear-resistance, and fixed composition of existing brazing filler metals, failing to meet the requirements of diverse brazing performance of workpieces. The present disclosure, by designing brazing filler metal morphology as at least one brazing filler metal tube sleeved on the outside of a strip-shaped wear-resistant body, achieves feasibility of changing compositions of the brazing filler metal according to brazing performance requirements, thus meeting the diverse requirements of the brazing for the workpieces, and making the joint strength of a brazed workpiece high and the wear-resistance good.

The second objective of the present disclosure is to provide a preparation method for the brazing filler metal. The method of the present disclosure is simple to operate, easy to implement, and highly efficient.

The third objective of the present disclosure is to provide use of the brazing filler metal in integrated brazing of shield cutter, oil drill bits, or cutting teeth.

To achieve the above objectives of the present disclosure, the following technical solutions are specially adopted.

A brazing filler metal includes a strip-shaped wear-resistant body and at least one brazing filler metal tube sleeved on the outside of the strip-shaped wear-resistant body, wherein the strip-shaped wear-resistant body includes a plurality of wear-resistant particles located in the core and a metal mesh wrapped around the outside of the plurality of wear-resistant particles, and outer surfaces of the wear-resistant particles are coated with a brazing flux layer.

Preferably, a mass ratio of the strip-shaped wear-resistant body to the entire brazing filler metal is 5%-8%.

Preferably, the mass ratio of the brazing flux layer to the strip-shaped wear-resistant body is 5%-10%.

Preferably, the mass ratio of the metal mesh to the strip-shaped wear-resistant body is 110%-20%.

Preferably, the mass ratio of the wear-resistant particles to the strip-shaped wear-resistant body is 70%-85%.

Preferably, a plurality of brazing filler metal tubes are sleeved on the outside of the strip-shaped wear-resistant body, and the plurality of brazing filler metal tubes have the same or different compositions.

Preferably, the brazing filler metal tubes include at least one of silver brazing filler metal tubes, copper brazing filler metal tubes, or aluminum brazing filler metal tubes.

Preferably, the strip-shaped wear-resistant body and the brazing filler metal tubes are in a clearance fit.

Preferably, the wear-resistant particles include at least one of aluminum nitride, SiC, TiC, and Cr3C2.

Preferably, the metal mesh includes any one of a stainless-steel wire mesh, a copper wire mesh, and a nickel wire mesh.

Preferably, a particle size of the wear-resistant particles is not smaller than a mesh pore size of the metal mesh.

Preferably, the brazing filler metal tube includes at least one silver brazing filler metal tube, the silver brazing filler metal tube including the following components by mass part:

Ag of 10-15 parts, Zn and Cu in a fixed ratio of 80-90 parts, Ti of 0.05-1.5 parts, Cr and Nb in a fixed ratio of 0.06-1.5 parts, and Co and Si in a fixed ratio of 0.8-3 parts.

Preferably, a mass ratio of Zn to Cu is 0.78-0.85:1.

Preferably, the mass ratio of Cr to Nb is 1.1-2:1.

Preferably, the mass ratio of Co to Si is 3.8-4.5:1.

A preparation method for the brazing filler metal according to according to any one of the abovementioned embodiments, including the following steps:
S1, immersing the wear-resistant particles in a semi-molten brazing flux solution, taking out the resultant after immersion, placing the resultant on the metal mesh, wrapping the wear-resistant particles with the metal mesh to be of strip-shaped, and cooling the resultant to obtain a strip-shaped wear-resistant body; and
S2, sleeving at least one brazing filler metal tube on the outside of the strip-shaped wear-resistant body, and securing ends of the strip-shaped wear-resistant body and the brazing filler metal tube with the metal mesh, to obtain the brazing filler metal.

Preferably, the preparation method for the brazing filler metal tube includes the following steps:
smelting raw materials for the brazing filler metal tube into a molten metal using a smelting method with inert gas protection, and casting the molten metal to obtain an ingot, and obtaining the brazing filler metal tube through piercing and hot extrusion.

Preferably, the brazing filler metal tube includes at least one silver brazing filler metal tube, the brazing flux is QJ102, a temperature of the immersion is 550-600° C., and a duration of the immersion is 10-20 min.

Use of the brazing filler metal according to any one of the abovementioned embodiments or the brazing filler metal prepared by the preparation method for the brazing filler metal according to any one of the abovementioned embodiments in integrated brazing of shield cutter, oil drill bits, or cutting teeth.

Compared with the prior art, the beneficial effects of the present disclosure are as follows.
(1) The brazing filler metal morphology provided by the present disclosure is designed as a plurality of brazing filler metal tubes sleeved on the outside of the strip-shaped wear-resistant body, realizing the feasibility of changing compositions of the brazing filler metal according to brazing performance requirements, thus meeting diverse requirements of brazing super hard tools.
(2) The metal mesh in the wear-resistant body of the present disclosure can dissolve into a brazing seam, further improving the joint strength. In addition, the wear-resistant particles in the wear-resistant body of the present disclosure are coated by a uniform brazing flux layer, allowing for achieving the brazing without adding the brazing flux, saving processes and improving efficiency.
(3) The brazing filler metal provided by the present disclosure is a high-performance brazing filler metal that integrates high strength, high wear-resistance, and high-temperature performance. The joint strength of the brazed workpiece is high and the wear-resistance is good.
(4) The present disclosure first heat-melts a uniform brazing flux layer onto the wear-resistant particles, then wraps the wear-resistant particles with a metal mesh with an appropriate pore inner diameter and secures them into a strip or a rod, and finally sleeves the brazing filler metal tubes on the outside to obtain a brazing filler metal with high strength, wear-resistance and replaceable components. The method of the present disclosure is simple to operate, easy to implement, and highly efficient.

### BRIEF DESCRIPTION OF THE DRAWINGS

In order to more clearly illustrate technical solutions of specific embodiments of the present disclosure or the prior art, drawings that need to be used in the description of the specific embodiments or the prior art will be briefly introduced below. Obviously, the drawings described below are for some embodiments of the present disclosure. Those ordinarily skilled in the art can also obtain other drawings based on these drawings without using any inventive efforts.

FIG. 1 is a schematic diagram of a longitudinal section structure of the brazing filler metal provided in an embodiment of the present disclosure;

FIG. 2 is a diagram of a brazing seam morphology of the brazing filler metal in Comparative Example 1 of the present disclosure; and

FIG. 3 is a diagram of a brazing seam morphology of the brazing filler metal in Example 1 of the present disclosure.

### REFERENCE NUMERALS

1—metal mesh; 2—brazing filler metal tube; 3—wear-resistant particles; and 4—brazing flux layer.

### DETAILED DESCRIPTION OF THE EMBODIMENTS

The implementations of the present disclosure will be clearly and completely described below in combination with drawings and specific embodiments, but those skilled in the art would understand that the following embodiments are some embodiments of the present disclosure, not all embodiments, are only used to illustrate the present disclosure, and should not be regarded as limitation to the scope of the present disclosure. Based on the embodiments of the present disclosure, all other embodiments obtained by those ordinarily skilled in the art without making inventive efforts shall fall within the scope of protection of the present disclosure. If the specific conditions are not specified, conventional conditions or conditions recommended by the manufacturer shall be followed. Reagents or instruments used without manufacturer designation are all conventional products that can be purchased through the market.

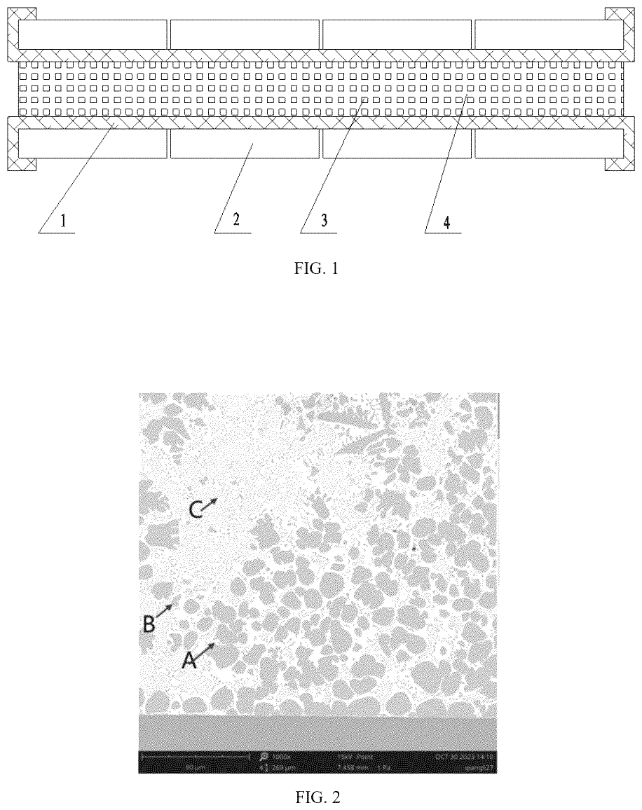

As shown in FIG. 1, the first aspect of the present disclosure provides a brazing filler metal, including a strip-shaped wear-resistant body and at least one brazing filler metal tube 2 sleeved on the outside of the strip-shaped wear-resistant body, the strip-shaped wear-resistant body including a plurality of wear-resistant particles 3 located in the core and a metal mesh 1 wrapped around the outside of the plurality of wear-resistant particles 3, and outer surface of the wear-resistant particles 3 being coated with a brazing flux layer 4.

The present disclosure provides a brazing filler metal with high strength, high wear-resistance and replaceable components. According to diverse and multi-level brazing performance requirements of super hard tools, the brazing filler metal tubes with a plurality of properties can be prepared. The brazing filler metal tubes on the outside of the wear-resistant strip can be replaced at any time according to performance requirements, realizing feasibility of changing compositions of the brazing filler metal at any time according to brazing performance requirements, thus meeting the diverse requirements of brazing for super hard tool. Brazing filler metal tubes with various and different compositions can also be sleeved on the outside of the same strip-shaped wear-resistant body, achieving a balance of a plurality of compositions of the brazing filler metal of the same brazing filler metal to adapt to the performance requirements for the brazing filler metal when brazing different parts of the workpiece, and realizing integrated high-strength and high-wear-resistant brazing of the super hard tools. For example, when brazing the super hard tools, the brazing filler metal tubes with different properties, such as high-wear-resistant brazing filler metal tubes, high-strength brazing filler metal tubes, and impact-resistant brazing filler metal tubes, can be prepared. According to service conditions of the workpiece, a suitable brazing filler metal tube is selected and sleeved on a wear-resistant strip to form diverse brazing filler metals.

In the present disclosure, the metal mesh 1 in the wear-resistant body can dissolve into a brazing seam, improving joint strength. The wear-resistant particles 3 in the wear-resistant body can enhance wear resistance, and outer surface of the wear-resistant particles 3 are coated by a uniform brazing flux layer 4, allowing for achieving brazing without adding the brazing flux.

In some specific embodiments of the present disclosure, a mass ratio of the strip-shaped wear-resistant body to the entire brazing filler metal is 5%-8%. For example, it can be any point value or a range value composed of two point values of 5%, 6%, 7%, and 8%.

The wear-resistant body plays a role in enhancing wear resistance, and the brazing filler metal plays a role of soldering. If the mass ratio of the wear-resistant body is below 5%, the wear-resistance enhancement effect is poor; while excessive amount of the wear-resistant body results in insufficient brazing filler metal that plays a bonding role, leading to low bonding strength between particles and a substrate, and easy detachment.

In some specific embodiments of the present disclosure, the mass ratio of the brazing flux layer 4 to the strip-shaped wear-resistant body is 5%-10%. For example, it can be any point value or a range value composed of two point values of 5%, 6%, 7%, and 8%, 9% and 10%. The brazing flux plays a role in film removal and flow aid. Insufficient brazing flux results in poor effect of film removal, while too much brazing flux produces brazing flux residue.

In some specific embodiments of the present disclosure, the mass ratio of the metal mesh 1 to the strip-shaped wear-resistant body is 10%-20%. For example, it can be any point value or a range value composed of two point values of 10%, 12%, 14%, 15%, 16%, 18%, and 20%.

The metal mesh is used to secure and fix the wear-resistant particles, and further enhances brazing seam strength by dissolving and diffusely distributing in the brazing seam. Too much metal mesh is unable to completely dissolve and diffusely distribute into the brazing seam; and insufficient metal mesh is unable to secure and encapsulate the wear-resistant particles and the brazing flux.

In some specific embodiments of the present disclosure, the mass ratio of the wear-resistant particles 3 to the strip-shaped wear-resistant body is 70%-85%. For example, it can be any point value or a range value composed of two point values of 70%, 72%, 75%, 78%, 80%, 82%, and 85%. The wear-resistant particles are a main body of the wear-resistant body. Too few wear-resistant particles are unable to play the role of enhancing the wear-resistance of the brazing seam; and too many wear-resistant particles make it difficult for the metal mesh to completely encapsulate them.

In some specific embodiments of the present disclosure, a plurality of brazing filler metal tubes 2 are sleeved on the outside of the strip-shaped wear-resistant body, and the plurality of brazing filler metal tubes 2 have the same or different compositions.

Only one brazing filler metal tube is sleeved on the outside of the strip-shaped wear-resistant body, then the required length of the brazing filler metal tube is relatively long, making it inconvenient for the strip-shaped wear-resistant body to insert. However, if a plurality of brazing filler metal tubes are sleeved on the outside of the strip-shaped wear-resistant body, the required length of single brazing filler metal tube is relatively shorter, making it convenient for the strip-shaped wear-resistant body to insert. In addition, it is also convenient to locally replace composition of the brazing filler metal to meet the brazing requirements of different parts of the workpiece. The sum of the length of the plurality of brazing filler metal tubes sleeved on the outside of the same strip-shaped wear-resistant body is the same as the length of the strip-shaped wear-resistant body.

A plurality of brazing filler metal tubes sleeved on the outside of the same strip-shaped wear-resistant body can have the same or different compositions, making it convenient for adjusting composition of the brazing filler metal according to the brazing requirements. For example, the brazing of the cutter head at the center of the shield cutter requires a high-silver brazing filler metal with a low melting temperature, while the brazing of the cutter head at the edge of the shield cutter requires a low-silver brazing filler metal with a slightly higher melting temperature and no spreading. In order to meet the brazing requirements of different parts, the silver brazing filler metal tubes with different compositions can be sleeved on the outside of the strip-shaped wear-resistant body to obtain a brazing filler metal with gradient silver content, so as to adapt to the integrated high-strength and high-wear-resistant brazing of the super hard tools such as shield cutter heads.

In some specific embodiments of the present disclosure, the length of each brazing filler metal tube 2 can be 100-150 mm. Controlling the length of the brazing filler metal tube 2 within the range allows for better insertion of the strip-shaped wear-resistant body.

In some specific embodiments of the present disclosure, the brazing filler metal tube 2 includes at least one of silver brazing filler metal tubes, copper brazing filler metal tubes, or aluminum brazing filler metal tubes. According to brazing for different workpieces, different brazing filler metal tubes can be selected to sleeve on the outside of the strip-shaped wear-resistant body to adapt to different brazing scenarios.

In some specific embodiments of the present disclosure, the strip-shaped wear-resistant body and the brazing filler metal tube 2 are in a clearance fit.

In some specific embodiments of the present disclosure, an outer diameter of the brazing filler metal tube 2 is 8-15 mm. In other embodiments, brazing filler metal tubes with other sizes can also be used according to application scenario requirements.

In some specific embodiments of the present disclosure, the wear-resistant particles 3 include at least one of aluminum nitride, SiC, TiC, and Cr3C2.

In some specific embodiments of the present disclosure, the metal mesh 1 includes any one of a stainless-steel wire mesh, a copper wire mesh, and a nickel wire mesh.

In some specific embodiments of the present disclosure, a particle size of the wear-resistant particles 3 is not smaller than a mesh pore size of the metal mesh 1, so as to avoid the leakage of wear-resistant particles.

In some specific embodiments of the present disclosure, the wear-resistant particles 3 used are of irregular shape. The maximum side length of the wear-resistant particles 3 is 0.8-1.5 mm. If the particle size is too large, the pores are large; and if the particles are too small, the wear-resistant effect is poor.

In some specific embodiments of the present disclosure, an inner diameter of the pores of the metal mesh 1 is 0.6-0.8 mm.

In some specific embodiments of the present disclosure, the brazing filler metal tube 2 includes at least one silver brazing filler metal tube, the silver brazing filler metal tube including the following components by mass part:

Ag of 10-15 parts, Zn and Cu in a fixed ratio of 80-90 parts, Ti of 0.05-1.5 parts, Cr and Nb in a fixed ratio of 0.06-1.5 parts, and Co and Si in a fixed ratio of 0.8-3 parts.

Ti is an active element in the composition, which can play a role in enhancing wetting of the wear-resistant body. Chromium and niobium can react to form a high-temperature strengthening phase Cr2Nb, enhancing high-temperature performance of the brazing filler metal. Cobalt and silicon can react to form diffusely distributed Co2Si strengthening phase in the brazing seam, significantly improving the strength of the brazing seam. The silver brazing filler metal formulation designed by the present disclosure has features of high strength, good high-temperature performance and excellent wear-resistance.

In some embodiments, typically but not limitingly, for example, in compositions of the silver brazing filler metal tube, the mass part of Ag can be any point value or a range value composed of two point values of 10 parts, 11 parts, 12 parts, 13 parts, 14 parts, or 15 parts; the mass part of Zn and Cu in a fixed ratio can be any point value or a range value composed of two point values of 80 parts, 82 parts, 85 parts, 88 parts, and 90 parts; the mass part of Ti can be any point value or a range value composed of two point values of 0.05 parts, 0.1 parts, 0.5 parts, 1 parts, and 1.5 parts; the mass part of Cr and Nb in a fixed ratio can be any point value or a range value composed of two point values of 0.06 parts, 0.5 parts, 1 part, 1.2 parts, and 1.5 parts; and the mass part of Co and Si in a fixed ratio can be any point value or a range value composed of two point values of 0.8 parts, 1 parts, 1.5 parts, 2 parts, 2.5 parts, and 3 parts.

In some specific embodiments of the present disclosure, in compositions of the silver brazing filler metal tube, the fixed ratio of Zn and Cu refers to a mass ratio of Zn to Cu of 0.78-0.85:1. For example, it can be any point value or a range value composed of two point values of 0.78:1, 0.79:1, 0.80:1, 0.81:1, 0.82:1, 0.83:1, 0.84:1, and 0.85:1. When the mass percentage of Ag in the brazing filler metal is 10-15%, by controlling the mass ratio of Zn to Cu within the above range, liquidus temperature of the brazing filler metal is lower, approximately 840° C., which can significantly reduce the liquidus temperature of the silver brazing filler metal.

In some specific embodiments of the present disclosure, in compositions of the silver brazing filler metal tube, the mass ratio of Cr to Nb is 1.1-2:1. For example, it can be any point value or a range value composed of two point values of 1.1:1, 1.3:1, 1.5:1, 1.8:1, and 2:1. When the mass ratio of chromium to niobium is 1.1-2:1, chromium reacts with niobium to form a reinforcing phase Cr2Nb, Cr is in excess, and excess Cr precipitates as reinforcing particles Cr, forming two reinforcing phases, Cr₂Nb and Cr, which are diffusely distributed in the brazing seam. Cr₂Nb can improve the high-temperature performance of the brazing filler metal, and Cr particles can improve the strength of the brazing filler metal, and simultaneously improve both the high-temperature performance and mechanical properties of the brazing filler metal. If the mass ratio of chromium to niobium is less than 1.1:1, Cr is insufficient, failing to forming the two reinforcing phases. If the mass ratio of chromium to niobium is greater than 2:1, it will lead to excessive precipitated Cr reinforcing particles, increasing brittle and hard phases of the brazing filler metal, making the brazing filler metal difficult to process.

In some specific embodiments of the present disclosure, in compositions of the silver brazing filler metal tube, the mass ratio of Co to Si is 3.8-4.5:1. For example, it can be any point value or a range value composed of two point values of 3.8:1, 4:1, 4.2:1, and 4.5:1. Co and Si can react to form a Co2Si reinforcing phase. By controlling the mass ratio of Co to Si within the above range, the molar ratio of Co to Si is about 2:1, which can basically completely react. If the mass ratio is too high or too low, it will result in too much Co or Si remaining. Co and Si are high-melting-point components, which will lead to increased brittleness, decreased toughness, and reduced joint strength of the brazing filler metal.

The second aspect of the present disclosure provides a preparation method for the brazing filler metal according to any one of the abovementioned embodiments, including the following steps:
S1, immersing the wear-resistant particles in a semi-molten brazing flux solution, taking out the resultant after immersion, placing the resultant on the metal mesh, wrapping the wear-resistant particles with the metal mesh to be of strip-shaped, and cooling the resultant to obtain a strip-shaped wear-resistant body; and
S2, sleeving at least one brazing filler metal tube on the outside of the strip-shaped wear-resistant body, and securing ends of the strip-shaped wear-resistant body and the brazing filler metal tube with the metal mesh (as shown in FIG. 1), thereby obtaining the brazing filler metal.

The method in the present disclosure innovatively heat-melts a uniform brazing flux layer onto the wear-resistant particles with suitable particle size, then wraps the wear-resistant particles with a metal mesh with an appropriate pore inner diameter and secures them into a strip or a rod. After cooling, the wear-resistant particles bond together and the strip-shaped wear-resistant body is obtained. Finally, a plurality of brazing filler metal tubes are sleeved on the outside to form the brazing filler metal with high strength, wear-resistance and replaceable compositions. The brazing filler metal prepared by the preparation method of the present disclosure has replaceable compositions, meeting the performance requirements of diverse and multi-level brazing of the super hard tools. In addition, the brazing flux is uniformly coated on the outer surface of the wear-resistant particles, and there is no need to add a brazing flux during brazing, saving processes and improving brazing efficiency. The metal mesh can dissolve into the brazing seam, increasing the joint strength.

The method of the present disclosure involves immersing the wear-resistant particles in a semi-molten brazing flux solution for coating because the brazing flux, in a semi-molten state, is in a glassy state with high viscosity, allowing it to coat and adhere to the surface of the wear-resistant particles, and improving coating effect. The brazing flux can be controlled in the semi-molten state by temperature.

In some specific embodiments of the present disclosure, the brazing filler metal tube can be obtained by purchase or by preparation.

In some specific embodiments of the present disclosure, the preparation method for the brazing filler metal tube includes the following steps:
smelting raw materials for the brazing filler metal tube into a molten metal using a smelting method with inert gas protection, and casting the molten metal to obtain an ingot, and obtaining the brazing filler metal tube through piercing and hot extrusion. Brazing filler metal tubes obtained directly by casting have more defects, while brazing filler metal tubes obtained by a method of ingot piercing and hot extrusion have better quality.

In some specific embodiments of the present disclosure, the brazing filler metal tube includes at least one silver brazing filler metal tube, the brazing flux is QJ102, and the temperature of the immersion is 550-600° C., for example, can be any point value or a range value composed of two point values of 550° C., 560° C., 570° C., 580° C., 590° C., and 600° C.; the duration of the immersion is 10-20 min, for example, can be any point value or a range value composed of two point values of 10 min, 12 min, 14 min, 15 min, 16 min, 18 min, and 20 min.

QJ102 is a silver brazing flux. Other brazing fluxes can also be used when using other brazing filler metal tubes. Controlling the temperature of the immersion at 550-600° C. is to keep the QJ102 brazing flux in the semi-molten state.

The third aspect of the present disclosure provides use of the brazing filler metal according to any one of the abovementioned embodiments, or the brazing filler metal prepared by the preparation method for the brazing filler metal according to any one the abovementioned embodiments, in the integrated brazing of super hard tools such as shield cutter, oil drill bits, or cutting teeth.

The embodiment solutions of the present disclosure will be described in detail below in conjunction with embodiments. However, those skilled in the art will understand that the following embodiments are only used to illustrate the present disclosure, and should not be regarded as limitation to the scope of the present disclosure. If the specific conditions are not specified in the embodiments, conventional conditions or conditions recommended by the manufacturer shall be followed. Reagents or instruments used without manufacturer designation are all conventional products that can be purchased through the market.

### Example 1

The example provided a brazing filler metal with high strength, high wear-resistance, and replaceable compositions. The silver brazing filler metal was of rod shape and included a strip-shaped wear-resistant body located in the core and a plurality of brazing filler metal tubes sleeved on the outside of the strip-shaped wear-resistant body.

The wear-resistant body accounted for 5% of the mass of the entire brazing filler metal and the wear-resistant body included three parts, i.e., the metal mesh, the wear-resistant particles, and the brazing flux layer. The brazing flux layer accounted for 5% of the mass of the wear-resistant body, the metal mesh accounted for 10% of the mass of the wear-resistant body, and the remaining part was the wear-resistant particles.

The wear-resistant particles were aluminum nitride, which were of irregular shape. A maximum side length was 0.8 mm, and the outside of the wear-resistant particles was uniformly coated by a brazing flux layer. The metal mesh used was a stainless-steel wire mesh with a wire diameter of 0.1 mm and an inner diameter of pores of 0.6 mm.

The brazing filler metal tube sleeved on the outside of the strip-shaped wear-resistant body can be replaced as needed according to the performance requirements.

The mass parts of various elements in the used silver brazing filler metal tube were as follows: Ag of 10 parts; Zn and Cu in a fixed ratio (Zn/Cu=0.78) of 80 parts, of which Cu was 44.94 parts and Zn was 35.06 parts; Ti of 0.05 parts; Cr and Nb in a fixed ratio (Cr/Nb=1.1) of 0.06 parts, of which Cr was 0.0314 parts and Nb was 0.0286 parts; and Co and Si in a fixed ratio (Co/Si=3.8:1) of 0.8 parts, of which Co was 0.634 parts and Si was 0.166 parts.

The preparation method included the following steps.

### (1) Preparation of Silver Brazing Filler Metal Tube

The raw materials Ag, Cu, Zn, Ti, Co, Cr, Nb, and Si of the silver brazing filler metal tube were weighed according to the mass parts and melted into a molten metal using a melting method with inert gas protection. The molten metal was injected into a graphite mold cavity, cooled, and demolded to obtain a brazing filler metal ingot. A seamless brazing filler metal tube with an outer diameter of 8 mm and an inner diameter of 5 mm was obtained through piercing and hot extrusion. The obtained seamless brazing filler metal tube was cut into the brazing filler metal tube with a length of 100 mm for later use.

### (2) Preparation of Silver Brazing Filler Metal

S1. The wear-resistant particles were immersed in a semi-molten silver brazing flux solution QJ102 at 550° C. After immersing for 10 min, the wear-resistant particles were taken out and placed on the metal mesh. The wear-resistant particles were wrapped with the metal mesh to be of a strip shape. After cooling, a strip-shaped wear-resistant body with a diameter of 5 mm, at the lower deviation limit of −0.1 mm, and a length of 2 m was obtained.

S2. 20 brazing filler metal tubes with an outer diameter of 8 mm, an inner diameter of 5 mm, and a length of 100 mm prepared in the present example were closely arranged and sleeved on the outside of the strip-shaped wear-resistant body prepared in step S1. The two ends of the strip-shaped wear-resistant body and the brazing filler metal tubes were secured and fixed by the metal mesh to obtain the silver brazing filler metal with a diameter of 8 mm, and having high strength, high wear-resistance and replaceable components.

### Example 2

The example provided a silver brazing filler metal with high strength, high wear-resistance, and replaceable compositions. The silver brazing filler metal was of rod shape and included a strip-shaped wear-resistant body located in the core and a plurality of brazing filler metal tubes sleeved on the outside of the strip-shaped wear-resistant body.

The wear-resistant body accounted for 7% of the mass of the entire brazing filler metal and the wear-resistant body included three parts, i.e., the metal mesh, the wear-resistant particles, and the brazing flux layer. The brazing flux layer accounted for 7% of the mass of the wear-resistant body, the metal mesh accounted for 15% of the mass of the wear-resistant body, and the remaining part was the wear-resistant particles.

The used wear-resistant particles were SiC, which were of irregular shape. A maximum side length was 1.0 mm, and the outside of the wear-resistant particles was coated with a brazing flux layer. The metal mesh used was a cooper wire mesh with a wire diameter of 0.2 mm and an inner diameter of pores of 0.7 mm.

The mass parts of various elements in the used silver brazing filler metal tube were as follows: Ag of 11 parts, Zn and Cu in a fixed ratio (Zn/Cu=0.8) of 82 parts, of which Cu was 45.55 parts and Zn was 36.45 parts; Ti of 0.1 parts, Cr and Nb in a fixed ratio (Cr/Nb=2:1) of 1 part, of which Cr was 0.67 parts and Nb was 0.33 parts; and Co and Si in a fixed ratio (Co/Si=4.5:1) of 1 part, of which Co was 0.82 parts and Si was 0.18 parts.

The preparation method was similar to that of Example 1, differences are as follows.

The prepared silver brazing filler metal tube was a seamless brazing filler metal tube with an outer diameter of 10 mm and an inner diameter of 7 mm, and the cutting length was 150 mm;

In step S1, the temperature of the immersion in the silver brazing flux solution was 580° C., and the duration of the immersion was 15 min; and the diameter of the strip-shaped wear-resistant body was 7 mm, the lower deviation limit was −0.1 mm, and the length is 3 meters.

In step S2, 20 brazing filler metal tubes with an outer diameter of 10 mm, an inner diameter of 7 mm, and a length of 150 mm, prepared in the present embodiment, were closely arranged and sleeved on the outside of the strip-shaped wear-resistant body in the present example. Therefore, a silver brazing filler metal with a diameter of 10 mm was obtained.

### Example 3

The example provided a silver brazing filler metal with high strength, high wear-resistance, and replaceable compositions. The silver brazing filler metal was of rod shape and included a strip-shaped wear-resistant body located in the core and a plurality of brazing filler metal tubes sleeved on the outside of the strip-shaped wear-resistant body.

The wear-resistant body accounted for 7.5% of the mass of the entire brazing filler metal and the wear-resistant body included three parts, i.e., the metal mesh, the wear-resistant particles, and the brazing flux layer. The brazing flux layer accounted for 8% of the mass of the wear-resistant body, the metal mesh accounted for 18% of the mass of the wear-resistant body, and the remaining part was the wear-resistant particles.

The used wear-resistant particles were TiC, which were of irregular shape. A maximum side length was 1.2 mm, and the outside of the wear-resistant particles was coated with a brazing flux layer. The metal mesh used was a nickel wire mesh with a wire diameter of 0.5 mm and an inner diameter of pores of 0.75 mm.

The mass parts of various elements in the used silver brazing filler metal tube were as follows: Ag of 12 parts, Zn and Cu in a fixed ratio (Zn/Cu=0.85) of 85 parts, of which Cu was 45.95 parts and Zn was 39.05 parts; Ti of 0.5 parts, Cr and Nb in a fixed ratio (Cr/Nb=1.1:1) of 1.5 parts, of which Cr was 0.79 parts and Nb was 0.71 parts; and Co and Si in a fixed ratio (Co/Si=4.0:1) of 2 parts, of which Co was 1.6 parts and Si was 0.4 parts.

The preparation method was similar to that of Example 1, differences are as follows.

The prepared silver brazing filler metal tube was a seamless brazing filler metal tube with an outer diameter of 15 mm and an inner diameter of 8 mm, and the cutting length was 100 mm.

In step S1, the temperature of the immersion in the silver brazing flux solution was 600° C., and the duration of the immersion was 20 min; and the diameter of the strip-shaped wear-resistant body was 8 mm, the lower deviation limit was −0.1 mm, and the length was 2 meters.

In step S2, 20 brazing filler metal tubes with an outer diameter of 15 mm, an inner diameter of 8 mm, and a length of 100 mm, prepared in the present example, were closely arranged and sleeved on the outside of the strip-shaped wear-resistant body in the present example, such that a silver brazing filler metal with a diameter of 15 mm was obtained.

### Example 4

The example provided a silver brazing filler metal with high strength, high wear-resistance, and replaceable compositions. The silver brazing filler metal was of rod shape and included a strip-shaped wear-resistant body located in the core and a plurality of brazing filler metal tubes sleeved on the outside of the strip-shaped wear-resistant body.

The wear-resistant body accounted for 8% of the mass of the entire brazing filler metal and the wear-resistant body included three parts, i.e., the metal mesh, the wear-resistant particles, and the brazing flux layer. The brazing flux layer accounted for 10% of the mass of the wear-resistant body, the metal mesh accounted for 20% of the mass of the wear-resistant body, and the remaining part was the wear-resistant particles.

The used wear-resistant particles were Cr2C3, which were of irregular shape. A maximum side length was 1.5 mm, and the outside of the wear-resistant particles was coated with a brazing flux layer. The metal mesh used was a stainless-steel wire mesh with a wire diameter of 0.3 mm and an inner diameter of pores of 0.8 mm.

The mass parts of various elements in the silver brazing filler metal tube were as follows: Ag of 14 parts, Zn and Cu in a fixed ratio (Zn/Cu=0.8) of 88 parts, of which Cu was 48.89 parts and Zn was 39.11 parts; Ti of 1 part, Cr and Nb in a fixed ratio (Cr/Nb=2:1) of 1.5 parts, of which Cr was 1 part and Nb was 0.5 parts; and Co and Si in a fixed ratio (Co/Si=4.5:1) of 3 parts, of which Co was 2.455 parts and Si was 0.545 parts.

The preparation method was similar to that of Example 1, differences are as follows.

The prepared brazing filler metal tube was a seamless brazing filler metal tube with an outer diameter of 12 mm and an inner diameter of 8 mm, and the cutting length was 100 mm.

In step S1, the temperature of the immersion in the silver brazing flux solution was 600° C., and the duration of the immersion was 20 min; and the diameter of the strip-shaped wear-resistant body was 8 mm, the lower deviation limit was −0.1 mm, and the length was 2 meters.

In step S2, 20 brazing filler metal tubes with an outer diameter of 12 mm, an inner diameter of 8 mm, and a length of 100 mm, prepared in the present embodiment, were closely arranged and sleeved on the outside of the strip-shaped wear-resistant body in the present embodiment. A silver brazing filler metal with a diameter of 12 mm was obtained.

### Example 5

The example provided a silver brazing filler metal with high strength, high wear-resistance, and replaceable compositions. The silver brazing filler metal was of rod shape and included a strip-shaped wear-resistant body located in the core and a plurality of brazing filler metal tubes sleeved on the outside of the strip-shaped wear-resistant body.

The wear-resistant body accounted for 8% of the mass of the entire brazing filler metal and the wear-resistant body included three parts, i.e., the metal mesh, the wear-resistant particles, and the brazing flux layer. The brazing flux layer accounted for 10% of the mass of the wear-resistant body, the metal mesh accounted for 20% of the mass of the wear-resistant body, and the remaining part was the wear-resistant particles.

The used wear-resistant particles were Cr2C3, which were of irregular shape. A maximum side length was 1.5 mm, and the outside of the wear-resistant particles was coated with a brazing flux layer. The metal mesh used was a stainless-steel wire mesh with a wire diameter of 0.3 mm and an inner diameter of pores of 0.8 mm.

The mass parts of various elements in the silver brazing filler metal tube were as follows: Ag of 15 parts, Zn and Cu in a fixed ratio (Zn/Cu=0.8) of 90 parts, of which Cu was 50 parts and Zn was 40 parts; Ti of 0.05 parts, Cr and Nb in a fixed ratio (Cr/Nb=1.5:1) of 1.2 parts, of which Cr was 0.72 parts and Nb was 0.48 parts; and Co and Si in a fixed ratio (Co/Si=4.2:1) of 0.8 parts, of which Co was 0.646 parts and Si was 0.154 parts.

The preparation method was exactly the same as that of Example 1.

### Example 6

The example provided a silver brazing filler metal with high strength, high wear-resistance, and replaceable compositions. The silver brazing filler metal was of rod shape and included a strip-shaped wear-resistant body located in the core and a plurality of brazing filler metal tubes sleeved on the outside of the strip-shaped wear-resistant body.

The wear-resistant body accounted for 5% of the mass of the entire brazing filler metal and the wear-resistant body included three parts, i.e., the metal mesh, the wear-resistant particles, and the brazing flux layer. The brazing flux layer accounted for 10% of the mass of the wear-resistant body, the metal mesh accounted for 20% of the mass of the wear-resistant body, and the remaining part was the wear-resistant particles.

The used wear-resistant particles were SiC and TiC with a mass ratio of 1:1, which were of irregular shape. A maximum side length was 1.5 mm, and the outside of the wear-resistant particles was coated with a brazing flux layer. The metal mesh used was stainless-steel wire mesh with a wire diameter of 0.3 mm and an inner diameter of the pores of 0.8 mm.

The mass parts of various elements in the used silver brazing filler metal tube were as follows: Ag of 10 parts, Zn and Cu in a fixed ratio (Zn/Cu=0.8) of 90 parts, of which Cu was 50 parts and Zn was 40 parts; Ti of 1 part, Cr and Nb in a fixed ratio (Cr/Nb=2:1) of 1.5 parts, of which Cr was 1 part and Nb was 0.5 parts; and Co and Si in a fixed ratio (Co/Si=4.2:1) of 1 part, of which Co was 0.808 parts and Si was 0.192 parts.

The preparation method was exactly the same as that of Example 1.

### Example 7

The example provided a silver brazing filler metal with high strength, high wear-resistance, and replaceable compositions. The silver brazing filler metal was of rod shape and included a strip-shaped wear-resistant body located in the core and a plurality of brazing filler metal tubes sleeved on the outside of the strip-shaped wear-resistant body.

The wear-resistant body accounted for 5% of the mass of the entire brazing filler metal and the wear-resistant body included three parts, i.e., the metal mesh, the wear-resistant particles, and the brazing flux layer. The brazing flux layer accounted for 5% of the mass of the wear-resistant body, the metal mesh accounted for 10% of the mass of the wear-resistant body, and the remaining part was the wear-resistant particles.

The wear-resistant particles were aluminum nitride, which were of irregular shape. A maximum side length was 0.8 mm, and the outside of the wear-resistant particles was uniformly coated with a brazing flux layer. The metal mesh used was a stainless-steel wire mesh with a wire diameter of 0.1 mm and an inner diameter of pores of 0.6 mm.

The silver brazing filler metal tubes used were those of Example 1 and Example 5.

The preparation method was similar to that of Example 1, differences are as follows.

In step S2, 20 brazing filler metal tubes sleeved on the outside of the wear-resistant body were of two metal compositions: 10 brazing filler metal tubes had the same composition as that in Example 1, and the other 10 brazing filler metal tubes had the same composition as that in Example 5.

### Comparative Example 1

Comparative Example 1 provided a conventional silver brazing filler metal, without the wear-resistant body. The silver brazing filler metal components, by mass parts, were as follows: Ag of 20 parts, Cu of 45 parts, Zn of 35 parts, and Ti of 0.05 parts.

The preparation method for the silver brazing filler metal was similar to the preparation method for the silver brazing filler metal tube in Example 1, and the only difference was that after obtaining the ingot, a solid silver brazing filler metal wire was obtained using a conventional extrusion and drawing method.

### Comparative Example 2

Comparative Example 2 was similar to Example 1, and the only difference was that it does not include the strip-shaped wear-resistant body. The solid silver brazing filler metal wire was obtained directly from the silver brazing filler metal ingot through the conventional extrusion and drawing method. The silver brazing filler metal composition was the same as that in Example 1.

### Comparative Example 3

Comparative Example 3 was similar to Example 1, and the only difference was that the composition of the silver brazing filler metal tube does not include Co. All other conditions were the same as those in Example 1.

### Comparative Example 4

Comparative Example 4 was similar to Example 1, and the only difference was that the composition of the silver brazing filler metal tube does not include Si. All other conditions were the same as those in Example 1.

### Comparative Example 5

Comparative Example 5 was similar to Example 1, and the only difference was that the composition of the silver brazing filler metal tube does not include Cr. All other conditions were the same as those in Example 1.

### Comparative Example 6

Comparative Example 6 was similar to Example 1, and the only difference was that the composition of the silver brazing filler metal tube does not include Nb. All other conditions were the same as those in Example 1.

### Comparative Example 7

Comparative Example 7 was similar to Example 1, and the only difference was that in the composition of the silver brazing filler metal tube, the mass ratio of Zn to Cu was 0.9. All other conditions were the same as those in Example 1.

### Comparative Example 8

Comparative Example 8 was similar to Example 1, and the only difference was that in the composition of the silver brazing filler metal tube, the mass ratio of Zn to Cu was 0.7. All other conditions were the same as those in Example 1.

### Comparative Example 9

Comparative Example 9 was similar to Example 1, and the only difference was that in the composition of the silver brazing filler metal tube, the mass ratio of Co to Si was 5. All other conditions were the same as those in Example 1.

### Comparative Example 10

Comparative Example 10 was similar to Example 1, and the only difference was that in the composition of the silver brazing filler metal tube, the mass ratio of Co to Si was 3. All other conditions were the same as those in Example 1.

### Comparative Example 11

Comparative Example 10 was similar to Example 1, and the only difference was that in the composition of the silver brazing filler metal tube, the mass ratio of Cr to Nb was 2.5. All other conditions were the same as those in Example 1.

### Comparative Example 12

Comparative Example 12 was similar to Example 1, and the only difference was that in the composition of the silver brazing filler metal tube, the mass ratio of Cr to Nb was 1.0. All other conditions were the same as those in Example 1.

### Comparative Example 13

Comparative Example 13 was similar to Example 1, and the only difference was that the wear-resistant body does not have the metal mesh, and the wear-resistant particles coated with the brazing flux layer were filled in the silver brazing filler metal tube in the flux-cored form. All other conditions were the same as those in Example 1.

### Experimental Example 1

To investigate brazed joint performance of the silver brazing filler metals in various examples and comparative examples, YG8 cemented carbide and 45 #steel were brazed using the silver brazing filler metals in various examples and comparative examples, and shear tests were conducted (implemented according to the provisions of GB/T11363). 20 samples were brazed for each type of the brazing filler metal. Brazing conditions were: heating to complete melting and holding for 15-20 s. The shear strength of the joints was tested at room temperature and after holding in a 300° C. oven for 5 min, respectively. The average value was taken to calculate strength loss rate: strength loss rate=(room-temperature strength−high-temperature strength)/room-temperature strength×100%. The test results are shown in Table 1.

TABLE 1

| | Average shear | Average shear | |
|---|---|---|---|
| | strength of | strength of | Strength |
| Type of brazing | joint at room | joint at high | loss |
| filler metal | temperature/MPa | temperature/MPa | rate/% |
| Brazing filler metal in | 242.6 | 218.34 | 10 |
| Example 1 | | | |
| Brazing filler metal in | 255.5 | 224.84 | 12 |
| Example 2 | | | |
| Brazing filler metal in | 265.8 | 235.23 | 11.5 |
| Example 3 | | | |
| Brazing filler metal in | 278.5 | 250.65 | 10 |
| Example 4 | | | |
| Brazing filler metal in | 287.5 | 257.58 | 10.5 |
| Example 5 | | | |
| Brazing filler metal in | 270.4 | 237.41 | 12.2 |
| Example 6 | | | |
| Brazing filler metal in | 241.8 (at low- | 216.9 (at low- | 10.3 |
| Example 7 | silver brazing | silver brazing | |
| | filler metal) | filler metal) | |
| | 285.8 (at high- | 254.6 (at high- | 10.9 |
| | silver brazing | silver brazing | |
| | filler metal) | filler metal) | |
| Brazing filler metal in | 175.3 | 113.9 | 35 |
| Comparative Example 1 | | | |
| Brazing filler metal in | 226.1 | 188.8 | 16.5 |
| Comparative Example 2 | | | |
| Brazing filler metal in | 205.3 | 168.3 | 18 |
| Comparative Example 3 | | | |
| Brazing filler metal in | 204.5 | 166.6 | 18.5 |
| Comparative Example 4 | | | |
| Brazing filler metal in | 202.1 | 163.7 | 19 |
| Comparative Example 5 | | | |
| Brazing filler metal in | 201.9 | 161.5 | 20 |
| Comparative Example 6 | | | |
| Brazing filler metal in | 230.5 | 195.9 | 15 |
| Comparative Example 7 | | | |
| Brazing filler metal in | 232.0 | 196.04 | 15.5 |
| Comparative Example 8 | | | |
| Brazing filler metal in | 220.3 | 187.7 | 14.8 |
| Comparative Example 9 | | | |
| Brazing filler metal in | 221.5 | 190.0 | 14.2 |
| Comparative Example 10 | | | |
| Brazing filler metal in | 215.6 | 185.8 | 13.8 |
| Comparative Example 11 | | | |
| Brazing filler metal in | 217.3 | 186.8 | 14 |
| Comparative Example 12 | | | |
| Brazing filler metal in | 195.2 | 156.2 | 20 |
| Comparative Example 13 | | | |

As can be seen from data in Table 1, the strength of the joint brazed by brazing filler metals in the examples is significantly higher than the strength of the joint of the brazing filler metals in the comparative examples. In particular, the shear strength of the joint in Example 5 is as high as 287.5 MPa, which is increased by about 64% compared than the shear strength 175.3 MPa of the joint brazed by the traditional silver brazing filler metal (Comparative Example 1). In addition, it can be seen from the strength loss rate of the joints at high temperature that the strength loss rate of the joints of the brazing filler metals in the examples is relatively low, approximately 1100, while the strength loss rate of the joints of the traditional silver brazing filler metals in Comparative Example 1 is as high as 350, verifying the better high-temperature resistance of the joints of the brazing filler metals in the examples.

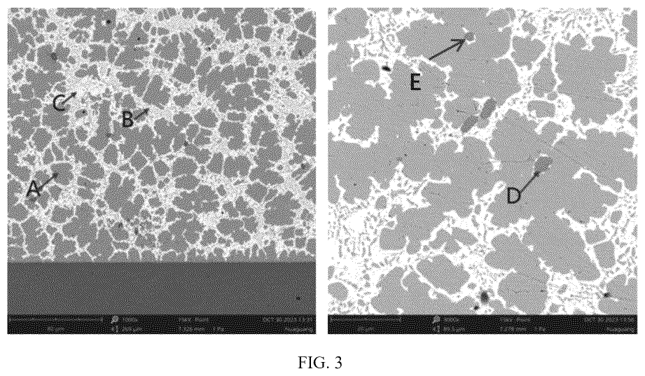

The brazing seam morphology of the brazing filler metal in Comparative Example 1 is shown in FIG. 2, and energy dispersive spectroscopy analysis results at different locations are shown in Table 2. The brazing seam morphology of the brazing filler metal in Example 1 is shown in FIG. 3, and the energy dispersive spectroscopy analysis results at different locations are shown in Table 3.

TABLE 2

| Location | Ag/at % | Cu/at % | Zn/at % | Ti at % | Possible phase |
|---|---|---|---|---|---|
| A | 3.34 | 64.08 | 32.37 | 0.21 | Copper-rich phase |
| B | 91.28 | 3.61 | 6.1 | 0 | Sliver-rich phase |
| C | 42.02 | 34.08 | 23.87 | 0 | Eutectic |

TABLE 3

| | Ag/ | Cu/ | Zn/ | Cr/ | Nb/ | Co/ | Si/ | Ti/ | Possible |
|---|---|---|---|---|---|---|---|---|---|
| Location | at % | at % | at % | at % | at % | at % | at % | at % | phase |
| A | 3.22 | 64.23 | 26.73 | 0 | 0 | 0 | 0 | 5.82 | Copper- |
| | | | | | | | | | rich |
| | | | | | | | | | phase |
| B | 41.21 | 29.48 | 28.97 | 0 | 0 | 0 | 0 | 0.33 | Eutectic |
| C | 72.98 | 12.33 | 14.00 | 0 | 0.53 | 0 | 0.19 | 0 | Sliver- |
| | | | | | | | | | rich |
| | | | | | | | | | phase |
| D | 0 | 0 | 0 | 0 | 0 | 67.5 | 32.5 | 0 | Co₂Si |
| E | 0 | 0 | 0 | 68.2 | 31.8 | 0 | 0 | 0 | Cr₂Nb |

As can be seen from the data in FIG. 2 and FIG. 3, as well as in Table 2 and Table 3, in Example 1, diffusely distributed Co2Si and Cr2Nb strengthening phases appear in the brazing seam of the brazing filler metal. This is the reason why the joint brazed by the brazing filler metal in the examples has high strength and good high-temperature resistance.

### Experimental Example 2

To investigate the wear-resistance of the silver brazing filler metals in various examples and comparative examples, a 3 mm brazing-filler-metal metallurgical layer was melted onto a 57 mm×25.5 mm×6 mm of 45 #steel substrate using the brazing filler metal in various examples and comparative examples, respectively. Abrasive wear test was conducted on the above samples using an MLG-130 dry-rubber-wheel abrasive wear tester. Testing parameters were: test load of 20N, abrasive of No. 120 brown corundum sand, rubber-wheel rotating speed of 100 r/min, sand flow rate of 100 g/min, and wear duration of 10 min. The wear of different tests was expressed by weight loss. The test results are shown in Table 4.

TABLE 4

| Type of brazing filler metal | Wear weight loss/g |
|---|---|
| Brazing filler metal in Example 1 | 13.5 |
| Brazing filler metal in Example 2 | 12.0 |
| Brazing filler metal in Example 3 | 11.1 |
| Brazing filler metal in Example 4 | 8.5 |
| Brazing filler metal in Example 5 | 8.0 |
| Brazing filler metal in Example 6 | 10.2 |
| Brazing filler metal in Example 7 | 14.5 (at low-silver |
| | brazing filler metal) |
| | 10.8 (at high-silver |
| | brazing filler metal) |
| Brazing filler metal in Comparative Example 1 | 27.8 |
| Brazing filler metal in Comparative Example 2 | 26.5 |
| Brazing filler metal in Comparative Example 3 | 18.5 |
| Brazing filler metal in Comparative Example 4 | 18.1 |
| Brazing filler metal in Comparative Example 5 | 17.5 |
| Brazing filler metal in Comparative Example 6 | 17.8 |
| Brazing filler metal in Comparative Example 7 | 16.3 |
| Brazing filler metal in Comparative Example 8 | 16.5 |
| Brazing filler metal in Comparative Example 9 | 15.3 |
| Brazing filler metal in Comparative Example 10 | 15.0 |
| Brazing filler metal in Comparative Example 11 | 14.8 |
| Brazing filler metal in Comparative Example 12 | 14.7 |
| Brazing filler metal in Comparative Example 13 | 24.8 |

As can be seen from the data in Table 4, the wear weight loss of the melted metallurgical layer of the brazing filler metal in the examples is less than the wear weight loss in the comparative examples. In particular, the wear weight loss of Example 5 is only 8.0 g, while the wear weight loss of Comparative Example 1 is as high as 27.8 g. This indicates that the wear-resistance of the sample of the examples is better.

Although the present disclosure has been illustrated and described with specific embodiments, it should be noted that the above various embodiments are only used to illustrate the technical solutions of the present disclosure, and not to limit them. Those ordinarily skilled in the art should understand that modifications can be made to the technical solutions described in the abovementioned various embodiments, or equivalent substitutions can be made to some or all of the technical features thereof, without departing from the spirit and scope of the present disclosure. These modifications or substitutions do not cause the essence of the corresponding technical solutions to deviate from the scope of the technical solutions of the various embodiments of the present disclosure; and therefore, it means that all such substitutions and modifications that fall within the scope of the present disclosure are included in the appended claims.

1. A brazing filler metal, comprising a strip-shaped wear-resistant body and at least one brazing filler metal tube sleeved on an outside of the strip-shaped wear-resistant body, wherein the strip-shaped wear-resistant body comprises a plurality of wear-resistant particles located in a core and a metal mesh wrapped around an outside of the plurality of wear-resistant particles, and outer surfaces of the plurality of wear-resistant particles are coated with a brazing flux layer.

2. The brazing filler metal according to claim 1, comprising at least one of following features:
(1) a mass ratio of the strip-shaped wear-resistant body to the brazing filler metal is 5%-8%;
(2) a mass ratio of the brazing flux layer to the strip-shaped wear-resistant body is 5%-10%;
(3) a mass ratio of the metal mesh to the strip-shaped wear-resistant body is 10%-20%; and
(4) a mass ratio of the plurality of wear-resistant particles to the strip-shaped wear-resistant body is 70%-85%.

3. The brazing filler metal according to claim 1, comprising at least one of following features:
(1) a plurality of brazing filler metal tubes are sleeved on the outside of the strip-shaped wear-resistant body, and the plurality of brazing filler metal tubes have a same or different compositions;
(2) the plurality of brazing filler metal tubes comprise at least one of silver brazing filler metal tubes, copper brazing filler metal tubes, or aluminum brazing filler metal tubes; and
(3) the strip-shaped wear-resistant body and the plurality of brazing filler metal tubes are in a clearance fit.

4. The brazing filler metal according to claim 1, comprising at least one of following features:
(1) the plurality of wear-resistant particles comprise at least one of aluminum nitride, SiC, TiC, and Cr₃C₂;
(2) the metal mesh comprises any one of a stainless-steel wire mesh, a copper wire mesh, and a nickel wire mesh; and
(3) a particle size of the plurality of wear-resistant particles is greater than or equal to a mesh pore size of the metal mesh.

5. The brazing filler metal according to claim 1, wherein the brazing filler metal tube comprises at least one silver brazing filler metal tube, and the silver brazing filler metal tube comprises following components by mass part:
Ag of 10-15 parts, Zn and Cu in a fixed ratio of 80-90 parts, Ti of 0.05-1.5 parts, Cr and Nb in a fixed ratio of 0.06-1.5 parts, and Co and Si in a fixed ratio of 0.8-3 parts.

6. The brazing filler metal according to claim 5, comprising at least one of following features:
(1) a mass ratio of Zn to Cu is 0.78-0.85:1;
(2) a mass ratio of Cr to Nb is 1.1-2:1; and
(3) a mass ratio of Co to Si is 3.8-4.5:1.

7. A preparation method for the brazing filler metal according to claim 1, comprising following steps:
S1, immersing the plurality of wear-resistant particles in a semi-molten brazing flux solution to obtain a first resultant, taking out the first resultant after the immersion, placing the first resultant on the metal mesh, wrapping the plurality of wear-resistant particles with the metal mesh to be of strip-shaped to obtain a second resultant, and cooling the second resultant to obtain the strip-shaped wear-resistant body; and
S2, sleeving the at least one brazing filler metal tube on the outside of the strip-shaped wear-resistant body, and securing ends of the strip-shaped wear-resistant body and the brazing filler metal tube with the metal mesh, to obtain the brazing filler metal.

8. The preparation method for the brazing filler metal according to claim 7, wherein a preparation method for the brazing filler metal tube comprises following steps:
smelting raw materials for the brazing filler metal tube into a molten metal using a smelting method with inert gas protection, casting the molten metal to obtain an ingot, and obtaining the brazing filler metal tube through piercing and hot extrusion.

9. The preparation method for the brazing filler metal according to claim 7, wherein the brazing filler metal tube comprises at least one silver brazing filler metal tube, a brazing flux is QJ102, a temperature of the immersion is 550° C.-600° C., and a duration of the immersion is 10 min-20 min.

10. Use of the brazing filler metal according to claim 1 in integrated brazing of shield cutters, oil drill bits, or cutting teeth.
